(19) United States
(12) Patent Application Publication
(10) Pub. No.: US 2005/0040731 A1
(43) Pub. Date: Feb. 24, 2005

(54) Static generator

(76) Inventor: Eric T. Schmidt, Wichita, KS (US)

Correspondence Address: SHOOK, HARDY & BACON LLP, 2555 GRAND BLVD, KANSAS CITY,, MO, 64108, US

(21) Appl. No.: 10/942,266

(22) Filed: Sep. 16, 2004

Related U.S. Application Data
(63) Continuation-in-part of application No. 10/198,462, filed on Jul. 18, 2002, now abandoned.
(60) Provisional application No. 60/306,512, filed on Jul. 18, 2001.

(51) Int. Cl. H02N 1/00

(52) U.S. Cl. 310/309

(57) ABSTRACT

A static generator is disclosed that has two hollow donut-like toroids. One toroid is placed within the other. When the outer toroid is counter rotated with respect to the inner toroid, static electricity is generated, and a magnetic field is produced.

### CROSS-REFERENCE TO RELATED APPLICATIONS

This application claims the benefit of and is a continuation-in-part of U.S. patent application Ser. No. 10/198,462, filed Jul. 18, 2002, which claims the benefit of U.S. Provisional Application No. 60/306,312 filed Jul. 18, 2001.

### STATEMENT REGARDING FEDERALLY SPONSORED RESEARCH OR DEVELOPMENT

None.

### BACKGROUND OF THE INVENTION

1. Field of the Invention

The present invention relates generally to the field of generating static electricity. More specifically, the present invention pertains to an apparatus used for generating static electricity. The static electricity is then utilized is such a way as to form a magnetic field.

2. Description of the Related Art

Van de Graff generators are well known devices, typically comprising a belt-and-roller type of generator. A roller of one material moves in relation to a fixed brush of an electrically neutral material, causing static charge to build on the roller and eventually force other charges to the electrically neutral brush. These types of generators are known to produce large amounts of voltage, mainly by stripping air molecules of their electrons and collecting them at a metal sphere.

Other types of electrostatic generators are know in the art, including those described in U.S. Pat. No. 5,248,930, where one surface moves with respect to a non moving second surface, and U.S. Pat. No. 4,990,113, where moving surfaces are in contact, causing a triboelectric effect. Another U.S. Pat. No. 401,156 discloses two counter-rotating drums used to generate static.

Other devices are known in the art which comprise loops of wire wound around a toroid-shaped form. As current moves through the wire loop, a magnetic field is produced in the direction of the axis of rotation of the current loops.

### SUMMARY OF THE INVENTION

The present invention produces static charges by the counter rotation of two closely-spaced toroids—one inside the other. The movement of the surfaces on these toroids produces a positive charging of the surfaces. These surfaces will then attract electrons from air molecules nearby. These bound surface electrons, along with the motion of the surfaces, cause electrons between the two surfaces to be repelled and move away from the surfaces. Particularly in a circular direction around the axis of movement of the two surfaces.

### BRIEF DESCRIPTION OF THE SEVERAL VIEWS OF THE DRAWINGS

The present invention is described in detail below with reference to the attached drawing figures, wherein:

FIG. 1 is an above view of the first embodiment, illustrating the counter-rotation of the two toroid shapes.

FIG. 2 is cross section of FIG. 1 taken at section 2-2, exposing the wheel/race system of the tear-shaped first embodiment of the present invention.

FIG. 3A is a perspective view showing the armature of the first embodiment with its attached wheels.

FIG. 3B shows the inner toroid of the first embodiment with its race.

FIG. 3C shows the outer toroid of the first embodiment with its race.

FIG. 4 is a broken out section showing a cross-sectional view of the wheels and races of the first embodiment.

FIG. 5 is a cross-sectional view of a second embodiment of the present invention.

FIG. 6 is a break out section highlighting the wheel/race arrangement of the second-inner-armature embodiment.

FIG. 7 is a cross-sectional view of section 7-7 taken out of the second embodiment shown in FIG. 5.

FIG. 8 is a cross-sectional view of a third outer circumscribing armature embodiment of the present invention.

### DETAILED DESCRIPTION OF THE INVENTION

The present invention provides a system and method for the generation of static charges which produce a moving circle of charge that may induce a magnetic field, for example in a toroid.

The preferred embodiment of the invention is an apparatus where a toroid shaped surface is placed within another toroid shaped surface, and the two surfaces are dynamically connected in such a way that they will counter-rotate with respect to one another. The outer surface of the interior toroid and the inner surface of the exterior toroid are ideally in close proximity to one another, allowing for only a few layers of air between them. When counter-rotated, air molecules attach to the inside surfaces (the outer surface of the interior toroid and the inner surface of the exterior toroid), positively charging the surfaces. The positively charged surfaces then attract electrons from the closest layer of air molecules, forming a static charge on the inside surfaces. The rotation of the statically charged surfaces will cause electrons in the air molecules not attached to the inside surfaces to roll in an axis approaching perpendicular to the counter-rotation of the toroids. The rolling rotation of the electrons will then induce a magnetic field according to Faraday's Law of Induction.

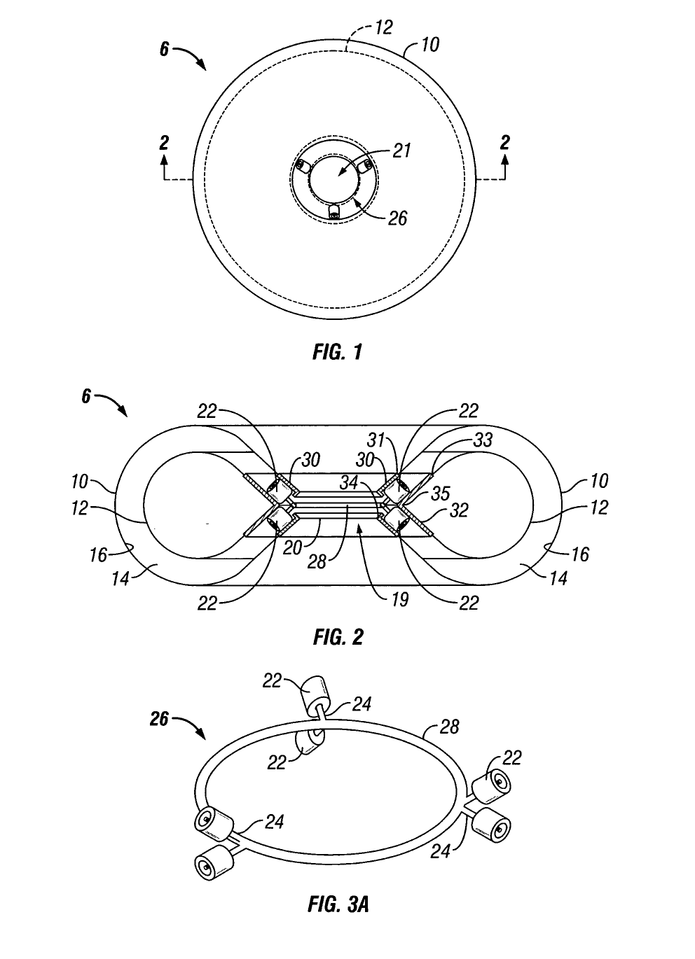

A first embodiment of the invention is shown in detail in FIGS. 1-4. Looking first to FIG. 1, the static generator of the present invention comprises an exterior toroid 10 and interior toroid 12 as illustrated. Though each toroid is disclosed having nominal thickness, it should be understood that these toroids in reality would have some thickness. Perhaps even substantial thickness. Thus, it should be understood that each toroid could have significant thickness and still fall within the scope of the present invention.

Layers of air are enclosed within a space 14 which is existent between the inside surfaces of the toroids, namely inner surface 16 of the exterior toroid 10 and the outer surface 18 of interior toroid 12.

A rotation device (not shown) is provided within the hole 20 defined through the two toroids. This rotation device rotates the exterior toroid in one direction and the interior toroid in a counter direction to that of the exterior toroid.

This is done using a driving mechanism. The likely embodiment of the driving mechanism is an electric motor (not shown), or some sort of mechanical device such as a hand cranked mechanism (not shown) or a bicycle-type foot actuated drive system (also not shown).

Referring to FIG. 2, also shows a more detailed view of a counter-rotation enabling set 19. An armature 26 and bearing set 22 create a stationary base around which the toroids counter rotate.

To begin the counter-rotational process, a rotational driving force is applied to the exterior toroid by one of the means described above. In the preferred embodiment to outer toroid 10. More specifically, onto the outside of a race 30 on outside toroid. The device used to drive outside toroid 10 would likely be positioned within opening 20. This, however, is a matter of choice. The driving device could be located in a location other than opening 20.

Instead of mechanically creating this rotational force to outer toroid 10, other means could be used. For example, the desired counter rotation could be created by manually spinning the outer toroid 10.

In the preferred embodiment, armature 26 remains stationary. It may either be fixed to some stationary component of the motor, or fixed in some other fashion. Because the armature 26 is fixed, the rotation of the outer toroid necessarily causes the rotation of the inner toroid in the opposite direction. This counter rotation is used for static generation.

According to the known laws of electromagnetism, the movement of electrons around the toroid shapes will follow a circular pattern around the radial axis of the counter-rotating toroid shapes. Thus, a magnetic field is induced, which, according to Faraday's Law, is directed in a perpendicular axis to the flow of electrons.

In the preferred embodiment of the invention, the interior and exterior toroids may be made of any material which will allow static charges to form on their surfaces. This includes almost any material. Therefore the scope of the invention should not be limited to that of a particular material. It might be desirable in some circumstances to choose a choice of material that more easily electrified by friction, or is ideally ideoelectric, such as vulcanized rubber. Other materials, however, will be known to those skilled in the art that will work also. Even ones that are not as ideoelectric. These different materials might even be highly electrically conductive, in order to create a different effect, if desired. Thus, the scope of the invention should not be limited to any particular material.

The device and operation of the first embodiment of FIGS. 1-4 will now be discussed in more detail. FIG. 1 is kind of an X-ray view of the present invention. From this figure it may be seen that the static generator of the first embodiment comprises outer toroid 10 and inner toroid 12. Also shown in this figure is that the device 6 includes an armature 26 which enables counter rotation of the toroids, one within the other.

Referring now to cross-sectional FIG. 2, we are able to see the inner workings of the device. This figure is actually taken at section two in FIG. 1. FIG. 2, however, makes it evident how the static generator of the first embodiment works. As may be seen in the figure, a space 14 is created between the inside surface 16 of outer toroid 10 and outside surface 18 of inner toroid 12. This space 14 is very important to the invention. This space 14 which is interposed between the rotating toroids 10 and 12. The modest spacing between the inner surface of the outer toroid, and the outer surface of the inner toroid enables the creation of static, which is the intended product of this invention.

The counter rotation between toroids 10 and 12 is enabled by a counter rotation set 19. Counter rotation set 19 comprises numerous parts. First, the device includes a race 30 for outer toroid 10. This race 30 has an inner rim which defines opening 20. Race 30 also has an outer edge of the race 31. The open center defined by the inside rim of race 30 may be viewed by referring back to FIG. 1. Race 30 also includes a rim 34. Rim 34 is also defined on race 30 and is used to retain an armature wheel set, as will be described hereinafter.

An inner race assembly 32 is also presented as part of the first embodiment. This race assembly 32 comprises an outer edge 33 and terminates in a V-shaped portion 35, outer surface of which receives the wheels on an armature 26.

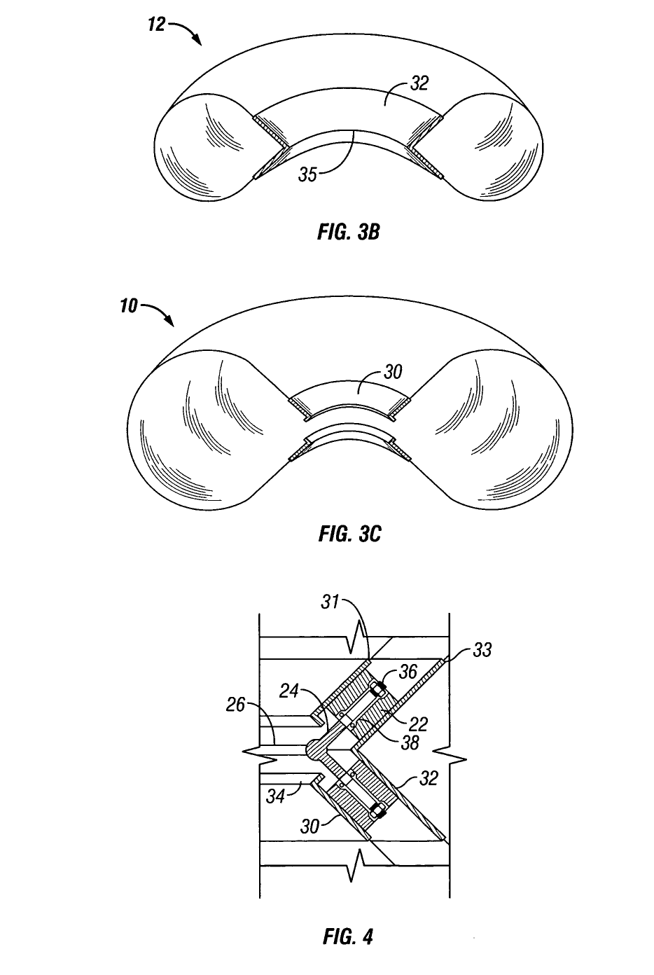

Armature assembly 26 may be seen in more detail in FIG. 3A. The figures shows the armature before it is assembled into the static generating device 6 between the two toroids. FIG. 3A shows a plurality of wheels 22 which are part of the armature assembly 26 are mounted on a plurality of angled shafts 24. These angled shafts 24 are all welded or otherwise fixed onto a ring member 28 at an acute angle to one another.

FIG. 4 shows the wheels and races of the first embodiment in more detail because it is a broken out section. Some features disclosed in this figure not yet disclosed are that the plurality of wheels 22 each possess a retaining mechanism (e.g. a nut) and a sleeve 38 with an enlarged opposing section. Sleeve 38 and nut 36 serve to maintain the wheel on the armature in a way which will be well known to those skilled in the art. Similar wheels have, e.g., been used on skateboards in the prior art. Here, however, these wheels will be used to enable the counter rotation of toroid 10 relative to toroid 12.

Armature 26 is the only part of device 6 which will remain stationary during operation of the device. As may be seen from FIG. 2, each of the wheels is pinned between inside race 32 and outer toroid race 30. The plurality of wheels 22 are able to roll freely on armatures 26.

The races 32 and 30 of the present invention may be seen from another perspective in FIGS. 3B and 3C respectively. These features are sections drawn to help in the understanding of how the races are configured on the toroid sections. As may be seen with respect to inner toroid 12 in FIG. 3B, the inner race 32 is what will receive the plurality of wheels 22 from inside. Referring then to FIG. 3C, we see that the race 30 on outer toroid 10 contains and engages the plurality of wheels 22 from the outside. Viewing these FIGS. 3B and 3C while reflecting back on FIG. 2 helps in this understanding. In FIG. 2 we see that if race 32 were rotated in such a way that it is coming out of the page, the wheels 22 would drive race 30 into the page. The reverse of this principal is also true. If race 30 is rotationally driven into the page, the wheels 22 would drive race 32 in a direction which would be out of the page.

In operation, armature 28 will be fixed to a portion of the motor, or some other stationary thing. The manner in which armature 28 is fixed is not shown in any of the figures, but one skilled in the art will understand that this may be done but simply welding or linking armature 28 to something stationary.

Races 30 and 32 are fixed to toroids 10 and 12 respectively. Thus, because these races counter rotate, the toroids also will rotate opposite one another. Considering this in a more three dimensional sense, race 30 would be traveling counter clockwise around an axis through the center of hole 21 whereas race 30 (as well as toroid 10) would be rotating in a clockwise fashion.

In the case that an electric motor is used, a wheel may be used to drive the outer toroid. The driving motor and driving wheel are not shown, but it will be understood to one in the art that motors able to drive rotating wheels are commercially available, and could easily be located and installed by one skilled in the art to impart rotation to the outside of race 30, or to any other part of outside toroid 10. It is preferable that the driving wheel would bear on the outside of race 30 of the outer toroid 10 because the outermost surface of the race 30 is exposed, and also located in close proximity to opening 21. Though the driving wheel is not shown, if such a wheel were to apply a force conceptionally pushing race 30 into the page, race 33 which is fixed to the inner toroid 12 would be forced to come out of the page, thus creating counter rotation.

Though the use of an electric motor and driving wheel has been described in most specificity herein, other means to drive the outer toroid could be used as well, such as mechanical pedaling devices, or simply manually rotating the outer race or toroid. Thus, all other driving means would also be included within the scope of the present invention.

It is also possible, in other embodiments, that the armature 26, not be fixed at all. In this case, the two toroids would still be able to rotate relative to one another. In such a case the armature, even though not fixed, would still enable the outer and inner toroids to rotate relative to one another. In the case that outer toroid 30 is angularly accelerated, the inner toroid 12 would likely rotate with it to a certain extent, but mostly not. This is because inner toroid 12 has significant mass and is able to rotates freely on the wheels 22. Because it is not being directly driven by anything, it would substantially drag behind the angular speed of the forcibly driven outer toroid. This difference in angular velocities, even though the inner toroid would rotate in the same direction as the outer toroid, would still create a counter rotation. Ultimately the rotational speed of the inner toroid would be significantly less than the speed of the outer toroid. Thus, the inner toroids rotation relative to that of the outer toroid would be a relative counter rotation. Even if this statement is semantically incorrect, the term “counter rotation” as used in this specification and in relation to this application is to be defined as including differences in angular velocity between the two toroids. Though it will typically be is desirable that armature 26 be stationary, and that the two toroids rotate in opposite angular directions, the device will still work even if the armature is not stationary. In such a case, the two toroids will rotate in the same angular direction, but will have substantially different speeds. This speed difference will result in the generation of static because the inside surface of the outer toroid is still moving relative to the outer surface of the inside toroid. Static is still generated just like with a true counter rotation setup where the armature is fixed. In the preferred embodiment, however, the armature is secured in some fashion to make it easier to generate greater counter rotation with less effort.

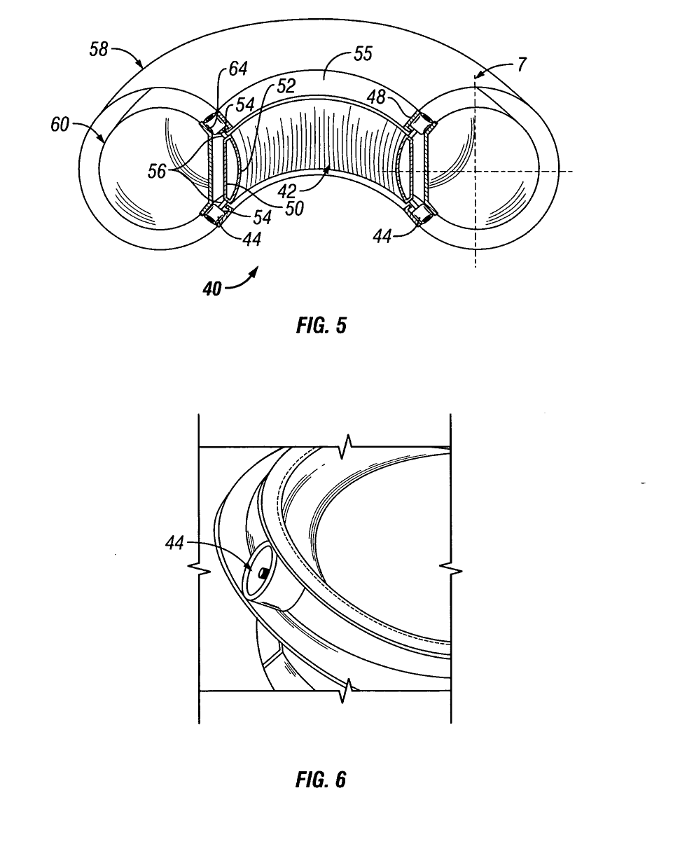

An alternative embodiment 40 of the present invention is shown in FIGS. 5-7A. Like the first embodiment, second embodiment 40 has an inner toroid 60 which is located inside an outer toroid 58. Device 40, however, has a different kind of armature 42. Armature 42 is internally disposed and has a D-shaped cross sectional appearance. Because it is located inside the toroids, an innermost surface 52 of the armature 42 defines the center hole of the static generator of the second embodiment 40. Internal armature 42 has disposed thereon a plurality of wheels 44. These wheels are received by a race 46 on the inner toroid. On the outer toroid, a race 48 is presented. The plurality of wheels 44 are received by races 46 and 48 to enable counter rotation much like the first embodiment. Unlike with the first embodiment, however, the internal armature 42 possesses a straight cross sectional portion 50, a curved inner most portion 52, and an angled wheel support section 54 which collectively create a D-shaped cross section. FIG. 5 shows all these features in cross section. The curved inner most portion 52 defines the hole through the static generation device. The angled wheel support, in cross section, is a straight short portion on which the angled shaft 56 are welded or otherwise fixed.

The outer toroid 58 and inner toroid 60 will counter rotate with this embodiment in much the same way in which the toroids of the first embodiment 6. Armature 42 is the only part shown in FIG. 5 that remains stationary. As with the earlier embodiment, this armature 42 could either be connected to the engine in some fashion, or fixed to some other stationary thing in a manner that will be within the skill of those skilled in the art. Like with the last embodiment, a wheel could drive the device by engaging an outer portion 55 of the race on the outer sleeve 58. Other means to rotate the outer toroid 58 could be employed as well. For example, the user could simply rotate the outer toroid 58 by pushing it with his hands. Regardless, upon the rotation of outer toroid 58, inner toroid 60 will automatically counter rotate because of the rotation of the wheels. Thus, just like the last embodiment, rotation of the outer sleeve 58 in a counter clockwise manner will result in the clockwise rotation of inner sleeve 60 and vice versa. Even if done at moderate speeds this will generate static as desired.

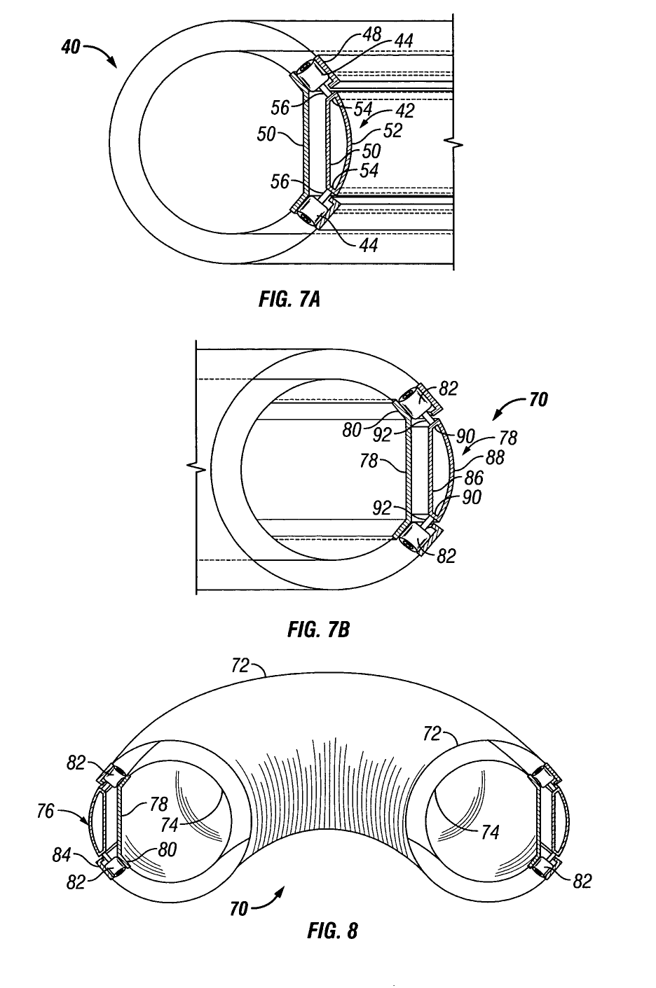

FIG. 6 shows how the plurality of wheels 44 are included between the races to create the desired counter rotation. The fundamentals of this counter rotation may also be seen in FIG. 7A where, conceptionally is easily able to perceive that the movement of race 48 on outer toroid 58 into the page will create a resultant compelling of race 46 out of the page. This is how the counter rotation is accomplished with this second embodiment—much like occurred with the first embodiment.

Disclosed in FIGS. 7B and 8 is a third embodiment 70. Third embodiment static generator 70 includes an outer toroid 72 and an inner toroid 74 just like the first two embodiments. Unlike these embodiments, however, an armature 76 is provided which is disposed on the outside of the toroids. Thus, these semicircular and external to the entire static generating device 70. It is essentially the same as the second embodiment, except that the third embodiment armature 76 of FIG. 7B is basically an inverted version of the former version of the second embodiment in FIG. 7A. Inverted such that the armature exists on the periphery of the device instead of the interior.

The second embodiment and third embodiment armatures are each more useful in certain situations. For some uses the armature and motor were more apt to be included within the hole of the device. In these cases, the centrally located armature 42 of the second embodiment would be more useful because the armature and races would be more accessible to the motor and drive wheel (not shown) which would be located near the hold. The third embodiment, however, might be more useful in a situation where it is desired that the motor and drive wheel are located somewhere external to the device 70. This is because the armature 76, which is the stationary component of the device, is obviously more accessible from the outside of the toroid with this arrangement. Conversely, the interior armature 42 of device 40 as the only stationary component is more accessible from the middle of the donut. Thus, practically speaking, the second embodiment would be more apt to be used for compelling or repelling things external to the device, whereas, the third embodiment would be more useful for the purpose of using the static generated to affect, e.g., propel, things through the hole defined by the “donut hole” of the device.

Now moving to more specifics regarding the third embodiment, we see that it's outside armature has a straight portion 86, a linear cross sectional portion 88, and an angled wheel bearing portion 90, which is a short angled plate on which the wheel shafts 92 are fixed. The plurality of wheels 82 on this embodiment 70 rotate about the shafts 92 and enable counter rotation much like that disclosed in the second embodiment.

As can be seen, the present invention and its equivalents are well-adapted to provide a new and useful static charge generator. Many different arrangements of the various components depicted, as well as components not shown, are possible without departing from the spirit and scope of the present invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out order described.

1. An apparatus for inducing a magnetic field, the apparatus comprising:
a first rotatable toroid;
a second rotatable toroid inside said first toroid wherein an outer surface of said second toroid is proximate an inner surface of said first toroid; and
wherein said first and second toroids are rotatable at different angular velocities relative to one another to form a flow of electrons which induce a magnetic field.

2. The apparatus of claim 1 wherein said toroids are adapted to counter rotate.

3. The apparatus of claim 1 comprising:
an armature supporting a plurality of wheels, one tangent of each wheel engaging a bearing surface on said first toroid, an opposite tangent of each wheel engaging a bearing surface of said second toroid, compelling said second toroid to rotate in a direction opposite to that of said first toroid.

4. The apparatus of claim 3 wherein said bearing surface on said first toroid comprises a first race and said bearing surface on said second toroid comprises a second race.

5. The apparatus of claim 3 wherein said armature is ring-shaped.

6. The apparatus of claim 3 wherein said armature extends around the interior of said first toroid.

7. The apparatus of claim 3 wherein said armature extends about the periphery of said toroid.
